(19) United States
(12) Patent Application Publication
(10) Pub. No.: US 2026/0086381 A1
(43) Pub. Date: Mar. 26, 2026

(54) REFRACTIVE BEAM SHAPING SYSTEM

(71) Applicant: Carl Zeiss Microscopy GmbH, Jena (DE)

(72) Inventors: Ziyao TANG, Jena (DE); Michael GOELLES, Jena (DE); Richard HOLLINGER, Jena (DE); Marco HANFT, Jena (DE); Ingo KLEPPE, Jena (DE); Ralf NETZ, Jena (DE)

(21) Appl. No.: 19/336,916

(22) Filed: Sep. 23, 2025

(30) Foreign Application Priority Data
Sep. 24, 2024 (DE) 10 2024 127 507.3

(51) Int. Cl. G02B 27/09

(52) U.S. Cl. CPC G02B 27/0955; G02B 27/0927

(57) ABSTRACT

A refractive beam-shaping system for a microscope. The beam-shaping system includes a zoom unit with light input and outputs sides. The zoom unit includes two lens groups that are movable along an optical axis, one group designed as a compensator and the other as a variator. The diameter of a light beam on the light output side can be set to a target diameter provided that the diameter of the light beam on the light input side is within a predetermined tolerance. The beam-shaping system also includes a beam-shaping unit downstream of the zoom unit in a beam direction and having at least four lens groups arranged in succession in the beam direction. A first and a second lens group reshape an intensity profile of the light beam; a third and a fourth lens group correct aberrations. The lenses of all groups have a spherical embodiment.

### CROSS-REFERENCE TO RELATED APPLICATIONS

This application claims the benefit of German Patent Application No. 10 2024 127 507.3, filed Sep. 24, 2024, the entire disclosures of which are incorporated herein by reference.

### FIELD OF THE INVENTION

The invention relates to a refractive beam shaping system for a microscope.

### BACKGROUND OF THE INVENTION

In research, laser light which has a high intensity and coherence is usually used for the illumination of samples in microscopic investigations. The irradiance and the phase of the light, in particular, play a role in the illumination of samples. Starting from the radiation sources, for example from fiber ends, the intensity profile usually has the shape of a Gaussian function around the optical axis, where the maximum is located. The disadvantage of this profile is that the edge regions of the field are illuminated with less intensity than the center. However, for some applications, such as super-resolution microscopy (SIM) with structured illumination or single-molecule localization microscopy (SMLM), the field must be illuminated as evenly as possible, which is why the intrinsic intensity profile of the laser light in the shape of a Gaussian function—also referred to as a Gaussian intensity profile—is reshaped by means of so-called beam shapers into an intensity profile with as uniform an intensity as possible, for example into a top-hat profile with a substantially rectangular intensity distribution. In a top-hat profile, the irradiance is constant over a predetermined area that is significantly smaller than the area covered by the Gaussian intensity profile. In the simplest case, only the central region of the Gaussian intensity profile is used for beam shaping, but this is inefficient.

For most applications, for example in wide-field microscopy, the field to be illuminated is macroscopic, i.e. beam diameters of more than 1 mm, for example 6 mm, are required. For such purposes, the laser beams coming from the radiation source are therefore initially expanded by virtue of a zoom unit being present in the beam path upstream of the beam shaper. Such a beam shaping system, which uses aspherical components, is described in U.S. Pat. No. 8,023,206 B2, for example.

In some microscopic systems, such as the ELYRA® from Carl Zeiss Microscopy GmbH, the uniformly illuminated surface is focused on a pinhole, which serves as a spatial filter. Subsequently, the light passes through further components, which are used to impress structures for structured illumination on the light. At the pinhole itself, the focused image should be diffraction limited. In order to keep the numerical aperture on the input and output sides constant, the use of a beam expander upstream of the beam shaping would therefore necessitate a further identical, but inversely arranged beam expander, which then compresses the beam again. However, this would go beyond the available compact size. For this reason, a beam shaping unit comprising an aperture close to the diameter of the laser beam used for illumination should be used where possible. In most cases, this diameter without the use of a beam expander is approximately 1 mm at the output of a single-mode fiber. However, scaling a similar beam shaping system, for example as described in U.S. Pat. No. 8,023,206 B2, for significantly larger beam diameters was found to be difficult, as aspherical lenses for beam shapers with apertures in the order of 1 mm cannot be polished to the corresponding values with sufficient accuracy.

Another problem relates to the correction of chromatic aberrations, as lasers of different wavelengths should be used for the illumination over the entire visible spectral range between 405 nm and 642 nm. A constant diameter of the laser beam independent of the wavelength and independent of the laser module used is desirable. In practice, however, the diameter of the laser beam at the fiber output depends on both the wavelength and the individual laser module used. For example, the target diameter of the laser beam at a wavelength of 546 nm is 0.86 mm for the system. Should the beam shaping unit be designed for these parameters, an almost ELYRA® homogeneous top-hat profile is obtained. However, use of the same laser module leads to a smaller beam diameter for longer wavelengths and an increase in the beam diameter for shorter wavelengths. This leads to significant deviations from the desired top-hat profile in the intensity distributions. There are further deviations as laser modules labeled as identical in design also emit laser beams with different diameters. Empirically, it was found that the deviations in the beam diameter from the target diameter are in the range of +10% to −10% around the target diameter. This means that deviations from the top-hat profile may occur even if the system is designed for the respective target diameter for a wavelength. Overall, the desired homogeneity of the intensity distribution therefore cannot be guaranteed.

### SUMMARY OF THE INVENTION

A problem addressed by the invention therefore consists of developing a refractive beam shaping system, which on the output side provides a beam for the entire visible wavelength range and for various laser modules of the same type, the intensity profile of said beam corresponding to a top-hat profile with high homogeneity over the illuminated surface irrespective of the wavelength, and which can be produced cost-effectively and whose size is small.

This problem is solved by a refractive beam shaping system comprising a zoom unit with a light input side and a light output side and a beam shaping unit arranged downstream of the zoom unit in a beam direction, i.e., on the light output side of the zoom unit. The zoom unit comprises two lens groups that are movable along an optical axis, one of which is configured as a compensator and the other as a variator. The compensator and the variator can be used to set the diameter of a light beam on the light output side to a target diameter provided that the diameter of the light beam on the light input side is within a predetermined tolerance. Depending on the individually used laser module, the diameter of the light beam formed as a laser beam in that case can be varied on the basis of the actual diameter on the light input side in this way such that said diameter on the light output side corresponds to a predetermined target diameter, for example 0.86 mm for a wavelength of 546 nm, with the target diameters for different colors differing slightly, however. The beam shaping unit comprises at least four lens groups, wherein a first and a second lens group reshape an intensity profile of the light beam and wherein a third and a fourth lens group correct aberrations. The lens groups of the zoom unit and the beam shaping unit can each contain a single lens or a plurality lenses. The lenses of all lens groups of the zoom unit and the beam shaping unit are moreover spherical, allowing a cost-effective and precise manufacture since the usual tools for polishing lens surfaces can be used, and there is no need to create any aspherical surfaces within a very small space.

By means of the compensator and the variator, the diameter of the laser beam used for illumination can thus be set within the predetermined tolerance, and so the diameter of the laser beam on the light output side corresponds to a target diameter, wherein the target diameters continue to vary in color-dependent fashion, however. The latter is due to the fact that the intention is to provide a zoom unit with a small number of lenses that is as compact as possible-decoupling the zoom factors and hence the diameter of the laser beam for the individual colors or wavelengths would require significantly more lenses and would not solve the problem under consideration here—the problem of a providing a compact and cost-effective beam shaping system. In this respect, a compromise was deliberately made here. Thus, the diameter of the laser beam is adjusted by means of the zoom unit; in this way, small differences in the beam diameters of laser modules labeled as identical in design are compensated for, and the dependence of the diameter on the laser module used is eliminated. The compensator can be configured as a single lens—as a so-called singlet—or as an achromatic lens group, by means of which chromatic aberrations are additionally corrected.

In this case, the tolerance is expediently predetermined on the basis of the variance of the diameter of a light beam of coherent light entering the zoom unit on the light input side. This variance results from the fact that for laser beams of the same wavelength, different laser modules labeled as identical in design, even from the same producer, emit laser beams whose beam diameter deviates from a target diameter as mean value. Empirically, examination of about 200 laser modules of the same type has shown that the—empirical—variance for the same wavelength can be up to 10% around the target diameter. In this respect, the specification of a tolerance in the range of +10% to −10% around the target diameter is sufficient for most applications. The zoom unit can be designed for larger tolerances, for example in the range of up to +25% to −25%, and also for smaller tolerances, for example in the range of +5% to −5% around the target diameter. However, large tolerances also require longer travel distances, which firstly increases the required installation space and secondly may lead to noticeable aberrations as only spherical lenses are used. In this respect, it is desirable to choose the tolerance to be just so large that the dependence of the beam diameter on the respective laser module used can be corrected.

Not only can the zoom unit be used to set the diameter of the laser beam to a target diameter, which is intended to be present at the output of the laser module and corresponds to a nominal magnification of 1, but moreover the nominal magnification of the zoom unit can in principle be predetermined as desired, although it should be guided by the actually required beam diameter which corresponds approximately to the diameter of the pinhole and ideally should be only slightly larger than the diameter of the latter in order to make the best use of the available intensity. In particular, the beam diameter can also be increased, i.e. the beam can be expanded, before the laser beam enters the beam shaping unit. Depending on the application, the nominal magnification may be between 0.7 and 2.5, for example. Even smaller or even larger nominal magnifications are possible. For example, if the zoom unit is designed for a nominal magnification of 1 and a tolerance of +/−10%, the magnification/reduction that can be set is in a range between 0.9 and 1.1, i.e. displacement paths are short. In the case of a nominal magnification of 2.0 and a tolerance of +/−10%, the magnification that can be set is between 1.8 and 2.2. An advantage in the use of a zoom unit thus lies in the fact that expanding the beam diameter to a larger target diameter increases the illuminated regions on the components of the beam shaping unit, facilitating their production. A further advantage lies in the fact that the zoom unit can be used equally for any desired color, even if the target diameters differ slightly for different colors.

In the beam shaping unit, the intensity profile of the light beam of coherent light is first reshaped to a predetermined profile, for example to a top-hat profile or to any other desired profile with high uniformity of intensity, by means of the first and second lens groups. Then, aberrations are reduced by wavefront corrections by means of the third and fourth lens groups.

As described, the diameter of the light beam on the output side of the zoom unit corresponds to a target diameter, the latter, however, still being dependent on the wavelength of the light albeit no longer being dependent on the individually used laser module for generating the light beam. The dependence of the beam diameter of the laser beam on the wavelength used is reflected in the fact that the beam diameter decreases as the wavelength increases, and so the intensity and energy efficiency are higher for longer wavelengths. The energy efficiency in this case is a measure of the proportion of the laser beam with a Gaussian profile—which has an infinite extent towards the sides, albeit with infinitesimal intensity—that can enter the downstream beam shaping unit since the diameter of the beam shaping unit is finite. The narrower the beam diameter after passing through the zoom unit, the greater the usable portion of the laser beam and the higher the energy efficiency. The higher intensity makes the correction of aberrations and the color-independent redistribution of the intensity to create a top-hat profile more difficult. However, it is not possible to achieve fully corrected reshaping of the intensity profile for each color since the number of components used should be kept low, and since the correction of aberrations and the reshaping of the intensity profile must be performed simultaneously for all colors. Rather, the refractive beam shaping system is designed to achieve the best possible compromise for all wavelengths and not just one wavelength. The compromise here lies in the fact that for shorter wavelengths up to about 560 nm after reshaping, the intensity is almost uniform across the diameter of the laser beam, and so the intensity distribution corresponds to a top-hat profile and the homogeneity is somewhat disturbed only for higher wavelengths such as 642 nm, for example. The intensity distribution at this wavelength in particular exhibits higher values at the center of the laser beam than at the edge; however, this was found to be not disturbing in practical tests, with even this somewhat reduced degree of homogeneity being acceptable for the intended microscopy methods such as SIM and SMLM.

For the purpose of imaging the reshaped light beam from the output side of the refractive beam shaping system on the pinhole, a focusing unit having elements known in the prior art and therefore not requiring a detailed explanation here is advantageously arranged downstream of the refractive beam shaping system in the beam direction. Since the image-side numerical aperture is small, the corrections of aberrations play only a minor role in this case. The focusing unit may be embodied as part of the refractive beam shaping system or embodied as an independent unit.

In order to keep the structure of the beam shaping unit as simple and cost-effective as possible the first, second, third and fourth lens groups of the beam shaping unit are formed as first single lens, second single lens, third single lens and fourth single lens, respectively, and two single lenses in each case are made of the same material. By preference, the first and the third single lens are made of a first material, and the second and the fourth single lens are made of a second material that differs from the first material.

Since the field corrections are already taken into account in the design of the beam shaping unit, the distance of the third lens group from the fourth lens group is greater than in other systems known from the prior art, for example from U.S. Pat. No. 8,023,206 B2. On account of the construction, the illuminated region on the front lens of the third lens group—as seen from the direction of the second lens group—is relatively small. The third lens group substantially acts like a field lens, which tends to separate the fields near a focal plane. For these reasons, and in view of the overall scale of the system, the production of the third lens group or third single lens is therefore complicated. In an advantageous configuration, an achromatic lens group consisting of for example two lenses is therefore arranged between the third and fourth lens groups of the beam shaping unit. This makes it possible, on the one hand, to bring the third lens group closer to the fourth lens group, whereby, on the other hand, the illuminated region on the third lens group, i.e. on the front-most lens thereof, can be enlarged, facilitating the production.

In the production or assembly of a microscope, which uses a laser module and the above-described refractive beam shaping system, the variator and compensator of the zoom unit are then set in such a way that they either increase or decrease the beam diameter for a reference color, for example green at 546 nm, to the target diameter, for example 0.86 mm, for the built-in laser module, which usually contains laser light sources for several wavelengths, or else increase said beam diameter to a predetermined target diameter dependent on the pinhole, i.e. expand the beam such that, for example, a doubling of the beam diameter corresponds to the target diameter.

It goes without saying that the features mentioned above and the features yet to be explained hereinafter can be used not only in the specified combinations but also in other combinations or on their own, without departing from the scope of the present invention.

### BRIEF DESCRIPTION OF THE DRAWINGS

The invention will be explained in even greater detail below on the basis of an exemplary embodiment with reference to the accompanying drawing, which likewise discloses features essential to the invention. This exemplary embodiment serves merely for elucidation and should not be construed as restrictive. For example, a description of an exemplary embodiment having a multiplicity of elements or components should not be construed as meaning that all these elements or components are necessary for implementation. Rather, other exemplary embodiments may also contain alternative elements and components, fewer elements or components, or additional elements or components. Modifications and variations that are described for one of the exemplary embodiments can also be applicable to other exemplary embodiments. In the drawing:

FIG. 1 shows a refractive beam shaping system.

### DETAILED DESCRIPTION

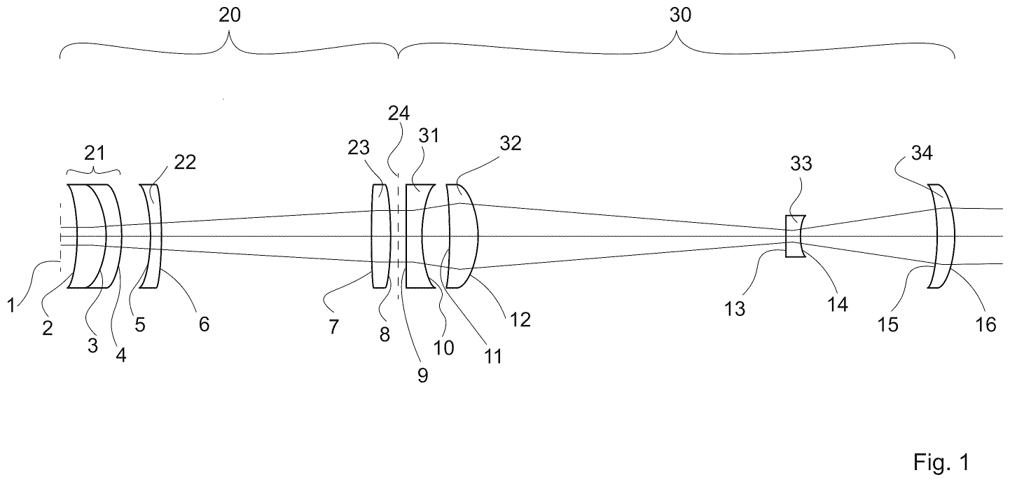

FIG. 1 shows an example of a refractive beam shaping system for a microscope, for example a microscope of the applicant's ELYRA® class. It comprises a zoom unit 20 having a light input side 1 and a light output side. The zoom unit 20 comprises two lens groups that are movable along an optical axis. The one lens group is embodied as a compensator 21 and the other lens group is embodied as a variator 22. By adjusting these two lens groups, the diameter of a light beam—usually a laser beam output coupled from a laser module and input coupled into the zoom unit 20 on the light input side 1—can be set to a target diameter on the light output side 24 provided that the diameter of the light beam on the light input side 1 is within a predetermined tolerance. In this case, the tolerance is preferably predetermined on the basis of the variance of the diameter of a light beam of coherent light entering into the zoom unit 20 on the light input side 1, wherein the variance is usually determined empirically by measurements on similar laser modules to be used in the microscope structure. It is self-evident that estimation and definition on the basis of empirical values is also possible. For the present example, the variance is in the range of +/−10% around the target diameter and therefore the tolerance is 10%. The zoom unit 20 has a nominal magnification between 0.7 and 2.5; in the example shown, the nominal magnification is 2.

A beam shaping unit 30 is arranged downstream of the zoom unit 20 in the beam direction, i.e., to the right of the light output surface 24 on the right-hand side in this case. In general, said beam shaping unit comprises at least four lens groups, which are arranged in succession in the beam direction. The first and second lens groups shape an intensity profile of a light beam entering into the beam shaping unit 30 from the zoom unit 20, specifically shaping said intensity profile into an intensity distribution corresponding to a top-hat profile from an intensity profile with a Gaussian intensity distribution. The third and fourth lens groups correct aberrations. In the example shown, the first, second, third and fourth lens groups of the beam shaping unit 30 are designed as single lenses, specifically as the first single lens 31, as the second single lens 32, as the third single lens 33 and as the fourth single lens 34. Moreover, the first single lens 31 and the third single lens 33 are made of a first material, and the second single lens 32 and the fourth single lens 34 are made of a second material that differs from the first material. All lenses, both of the zoom unit 20 and of the beam shaping unit 30, have a spherical embodiment.

The zoom unit 20 with a nominal magnification of 2 can for example be realized using lenses that have the optical design data listed in table 1 below. In this context, the radius is denoted by r, the thickness by D and the distance between two respective lenses by a. The specifications relating to these three variables are given in millimeters. The refractive indices n_{d} refer to the wavelength of 587.56 nm, and the Abbe numbers ν_{d} correspondingly do so as well. The surfaces of the lenses are numbered and are labeled accordingly in FIG. 1.

TABLE 1
Optical parameters of the zoom unit 20

| Surface | | | | | |
|---|---|---|---|---|---|
| No. | r | D | a | n_{d} | ν_{d} |
| 1 | ∞ | | 2.816 | | |
| 2 | −18.824 | 2.000 | | 1.61 | 43.7 |
| 3 | −5.515 | 1.500 | | 1.61 | 56.7 |
| 4 | −8.989 | | 2.804 | | |
| 5 | −7.750 | 2.000 | | 1.95 | 30.6 |
| 6 | −16.867 | | 59.381 | | |
| 7 | 1182.848 | 2.000 | | 1.49 | 70.4 |
| 8 | −58.335 | 5.000 | | | |

Accordingly, the beam shaping unit 30 can also be realized, for example, using lenses having the optical design data listed in table 2 below, with the abbreviations being the same as those used in connection with table 1. Here, too, the surfaces of the lens are numbered and correspondingly labeled in FIG. 1.

TABLE 2
Optical parameters of the beam shaping unit 30

| Surface | | | | | |
|---|---|---|---|---|---|
| No. | r | D | a | n_{d} | ν_{d} |
| 9 | ∞ | 2.000 | | 1.59 | 61.3 |
| 10 | 3.838 | | 1.804 | | |
| 11 | −31.328 | 2.000 | | 1.44 | 94.9 |
| 12 | −3.557 | | 74.999 | | |
| 13 | ∞ | 2.000 | | 1.59 | 61.3 |
| 14 | 3.342 | | 24.697 | | |
| 15 | −27.290 | 2.500 | | 1.44 | 94.9 |
| 16 | −10.266 | | 20.000 | | |

In an embodiment not shown here, an achromatic lens group can also be arranged between the third and the fourth lens group of the beam shaping unit 30 and used to enlarge the illuminated region on the third lens group. The distance between the third lens group and the fourth lens group can be reduced in this way.

The refractive beam shaping system according to the invention described above can be used particularly well in the field of fluorescence microscopy, in which a sample is illuminated using laser light sources in the visible wavelength range, but can also be used in other fields, for example if the microscopes have a limited installation space. The production complexity and hence the costs can be reduced since no aspherical lenses are used. The intensity profile is also reshaped with a high energy efficiency of more than 88% for all wavelengths in the visible range.

List of reference signs

| | |
|---|---|
| 1 | Light input side |
| 2 . . . 16 | Lens surface |
| 20 | Zoom unit |
| 21 | Compensator |
| 22 | Variator |
| 23 | Lens |
| 24 | Light output side |
| 30 | Beam shaping unit |
| 31 | First single lens |
| 32 | Second single lens |
| 33 | Third single lens |
| 34 | Fourth single lens |

1. A refractive beam shaping system for a microscope, comprising:
a zoom unit having a light input side and a light output side, wherein the zoom unit comprises two lens groups that are movable along an optical axis, one of said lens groups being configured as a compensator and the other as a variator by means of which the diameter of a light beam on the light output side can be set to a target diameter provided that a diameter of the light beam on the light input side is within a predetermined tolerance, and
a beam shaping unit arranged downstream of the zoom unit in a beam direction and having at least four lens groups arranged in succession in the beam direction, wherein a first and a second lens group reshape an intensity profile of the light beam and wherein a third and a fourth lens group correct aberrations,
wherein the lenses of all lens groups of the zoom unit and of the beam shaping unit are spherical.

2. The refractive beam shaping system as claimed in claim 1, wherein the tolerance is predetermined on the basis of a variance of a diameter of a light beam of coherent light entering the zoom unit on the light input side.

3. The refractive beam shaping system as claimed in claim 1, wherein the predetermined tolerance is 10%.

4. The refractive beam shaping system as claimed in claim 1, wherein the zoom unit has a nominal magnification between 0.7 and 2.5.

5. The refractive beam shaping system as claimed in claim 1, wherein the first, second, third and fourth lens groups of the beam shaping unit are formed as first single lens, second single lens, third single lens and fourth single lens, respectively, and two single lenses in each case are made of the same material.

6. The refractive beam shaping system as claimed in claim 5, wherein the first single lens and the third single lens are made of a first material, and the second single lens and the fourth single lens are made of a second material that differs from the first.

7. The refractive beam shaping system as claimed in claim 1, comprising a zoom unit defining eight lens surfaces, having a nominal magnification of 2 and the following optical design data with radii r, thicknesses D and distances a in mm, refractive indices n_{d} at a wavelength of 587.56 nm and the Abbe numbers ν_{d} for each of the respective eight lens surfaces, numbered 1 to 8 below:

| Surface | | | | | |
|---|---|---|---|---|---|
| No. | r | D | a | n_{d} | ν_{d} |
| 1 | ∞ | | 2.816 | | |
| 2 | −18.824 | 2.000 | | 1.61 | 43.7 |
| 3 | −5.515 | 1.500 | | 1.61 | 56.7 |
| 4 | −8.989 | | 2.804 | | |
| 5 | −7.750 | 2.000 | | 1.95 | 30.6 |
| 6 | −16.867 | | 59.381 | | |
| 7 | 1182.848 | 2.000 | | 1.49 | 70.4 |
| 8 | −58.335 | 5.000 | | | |

8. The refractive beam shaping system as claimed in claim 1, comprising a beam shaping unit defining eight lens surfaces with the following optical design data with radii r, thicknesses D and distances a in mm, refractive indices n_{d} at a wavelength of 587.56 nm and the Abbe numbers ν_{d} for each of the respective eight lens surfaces, numbered 9 to 16 below:

| Surface | | | | | |
|---|---|---|---|---|---|
| No. | r | D | a | n_{d} | ν_{d} |
| 9 | ∞ | 2.000 | | 1.59 | 61.3 |
| 10 | 3.838 | | 1.804 | | |
| 11 | −31.328 | 2.000 | | 1.44 | 94.9 |
| 12 | −3.557 | | 74.999 | | |
| 13 | ∞ | 2.000 | | 1.59 | 61.3 |
| 14 | 3.342 | | 24.697 | | |
| 15 | −27.290 | 2.500 | | 1.44 | 94.9 |
| 16 | −10.266 | | 20.000 | | |

9. The refractive beam shaping system as claimed in claim 1, wherein an achromatic lens group is arranged between the third and fourth lens groups of the beam shaping unit and used to enlarge the illuminated region on the third lens group.
